(19) United States
(12) Patent Application Publication
(10) Pub. No.: US 2010/0046990 A1
(43) Pub. Date: Feb. 25, 2010

(54) Image Forming Apparatus

(75) Inventors: Koichi KAMIJO, Matsumoto-shi (JP); Satoshi CHIBA, Suwa-shi (JP); Hiroshi TOYAMA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/543,093

(22) Filed: Aug. 18, 2009

(30) Foreign Application Priority Data
Aug. 19, 2008 (JP) 2008-210355

(51) Int. Cl. G03G 15/01

(52) U.S. Cl. 399/298

(57) ABSTRACT

An image forming apparatus includes: a photoconductor drum; a transfer belt wound around the photoconductor drum and configured to move in a first direction; and a transfer member configured to come into abutment with the photoconductor drum at an abutment position via the transfer belt, wherein the transfer belt comes into contact with the photoconductor drum at a first position and comes out of contact with the photoconductor drum at a second position, and a peripheral surface length of the photoconductor drum between the abutment position and the second position is larger than a peripheral surface length of the photoconductor drum between the first position and the abutment position.

### CROSS-REFERENCE TO RELATED APPLICATIONS

This application claims the benefit of priority under 35 USC 119 of Japanese application no. 2008-210355, filed on Aug. 19, 2008, which is incorporated herein by reference.

### BACKGROUND

1. Technical Field

The present invention relates to an image forming apparatus and, more specifically, to an image forming apparatus using liquid developer obtained by dispersing toner in carrier liquid.

2. Related Art

An image forming apparatus having photoconductor drums, a transfer belt such as an intermediate transfer belt, and transfer members (transfer roller, or the like) which come into abutment with the photoconductor drums via the transfer belt is known. As the image forming apparatus as described above, a configuration in which a transfer roller 51 is brought into abutment with an upper end portion of a photoconductor drum 10 in a state in which an intermediate transfer belt 80 is interposed therebetween, and wound portions 80L and 80R having substantially the same length are formed on both sides of the abutment position between the transfer roller 51 and the photoconductor drum 10 as shown in FIG. 5 is disclosed (see FIG. 1 in JP-A-2001-166611).

However, in this example in the related art, the transfer efficiency at the time of transferring a developer image on the photoconductor drum 10 to the intermediate transfer belt 80 is not sufficient as matters stand.

### SUMMARY

An advantage of some aspects of the invention is to provide an image forming apparatus in which the transfer efficiency at the time of transferring an image on a photoconductor drum to a transfer belt is improved.

After having devoted ourselves to the study for achieving the above-described advantage, the inventors could gain the following findings. In other words, when an arcuate nip N is formed by winding the intermediate transfer belt 80 over the photoconductor drum 10 as shown in FIG. 5, the nip N may be divided into two segments as follows for the sake of convenience. That is, it may be divided into a segment positioned on the upstream side of a straight line P1 connecting a rotation center (axial center) 54 of a primary transfer roller 51 and a rotation center (axial center) 14 of the photoconductor drum 10 along the direction of movement of the intermediate transfer belt 80 (hereinafter, referred to as an “upstream winding nip segment A”) and a segment on the downstream side thereof along the direction of movement of the intermediate transfer belt 80 (hereinafter, referred to as a “downstream winding nip segment B”).

However, the inventors found that the transfer efficiency is lowered in a configuration in which the width of the upstream winding nip segment A (hereinafter, referred to as an “upstream winding nip width”) and the width of the downstream winding nip segment B (hereinafter, referred to as a “downstream winding nip width”) are secured by the same extent as regards the nip N. The inventors assume that the reason of that is as follows. When the intermediate transfer belt 80 and a toner layer on the photoconductor drum 10 come into contact with each other at a portion A1 on the upstream winding nip segment A where an electric field is not provided, the toner layer is mechanically pressed against the photoconductor drum 10 so that the toner layer can hardly be separated from the photoconductor drum 10, or electric charge of the toner becomes unstable due to electric discharge at a minute gap in the upstream winding nip segment A, whereby the transfer efficiency is lowered. Detailed description about this point will be given later.

After having further devoted to the study, the inventors have obtained findings that improvement of the transfer efficiency is achieved by relatively reducing the upstream winding nip width, whereby the invention has completed.

An image forming apparatus according to a first aspect of the invention includes:

a photoconductor drum;

a transfer belt wound around the photoconductor drum and configured to move in a first direction; and

a transfer member configured to come into abutment with the photoconductor drum at an abutment position via the transfer belt, wherein

the transfer belt comes into contact with the photoconductor drum at a first position and comes out of contact with the photoconductor drum at a second position, and

a peripheral surface length of the photoconductor drum between the abutment position and the second position is larger than a peripheral surface length of the photoconductor drum between the first position and the abutment position.

As the “transfer belt” in this specification is exemplified by (a) an intermediate transfer belt configured to transport a developer image transferred from the photoconductor drum to a second transfer position as well as (b) a transfer belt including a recording medium transporting belt and a recording medium (sheet, film, cloth, etc.) to be held by the recording medium transporting belt and transported together with the recording medium transporting belt.

An image forming apparatus according to a second aspect of the invention includes:

a photoconductor drum;

a transfer belt wound around the photoconductor drum and configured to move in a first direction; and

a transfer roller configured to come into abutment with the photoconductor drum via the transfer belt, wherein

the photoconductor drum rotates in a first direction of rotation when viewing an axial cross-section of the photoconductor drum, the transfer belt comes into contact with the photoconductor drum at a contact position positioned in the direction of rotation opposite from the first direction of rotation with respect to an intersecting point between a straight line connecting axial centers of the photoconductor drum and the transfer roller and an outer peripheral surface of the photoconductor drum, is wound around the photoconductor drum in the first direction of rotation, and then comes out of contact therewith at a separated position positioned in the first direction of rotation with respect to the intersecting point, and

a peripheral surface length L2 of the photoconductor drum between the intersecting point and the separated position is larger than a peripheral surface length L1 of the photoconductor drum between the contact position and the intersecting point.

Preferably, a resilient member which presses the transfer roller against the photoconductor drum, and a support roller disposed on the side of the transfer roller from between the side of the transfer roller and the side of the photoconductor drum with reference to the transfer belt and configured to press the transfer belt toward the photoconductor drum are provided.

Preferably, the transfer belt is wound around and stretched between a first roller and a second roller and the photoconductor drum comes into abutment with a surface of the transfer belt transported from the first roller to the second roller, and a support roller is disposed on the side of the transfer roller from between the side of the transfer roller and the side of the photoconductor drum with reference to the transfer belt and on the side of the first roller with respect to the contact position is provided.

Preferably, a squeezing member configured to squeeze developer on the photoconductor drum and a collecting member configured to collect the developer squeezed by the squeezing member are provided, and the collecting member is arranged at a position below the support roller in the vertical direction, and includes an opening which opens upward in the vertical direction.

Preferably, the transfer belt comes into abutment with the support roller, the transfer roller, and the photoconductor drum in this order.

Preferably, the peripheral surface length L1 of the photoconductor drum is zero (L1=0), or approximately zero (L1≈0). As a case where L1≈0 is satisfied, that is, when the “length L1 is approximately zero”, a value selected from “0<L1≦1” is exemplified.

An image forming apparatus according to a third aspect of the invention includes:

a photoconductor drum for yellow developer configured to rotate in a first direction and develop yellow developer;

a photoconductor drum for magenta developer configured to rotate in the first direction and develop magenta developer;

a photoconductor drum for cyan developer configured to rotate in the first direction and develop cyan developer;

a photoconductor drum for black developer configured to rotate in the first direction and develop black developer;

a transfer belt configured to be wound around the photoconductor drum for the black developer; and

a first transfer roller configured to come into abutment with the photoconductor drum for the black developer at an abutment position via the transfer belt, wherein

the transfer belt comes into contact with the photoconductor drum for the black developer at a first position and comes out of contact with the photoconductor drum for the black developer at a second position, and

a peripheral surface length of the photoconductor drum for the black developer between the abutment position and the second position is larger than a peripheral surface length thereof between the first position and the abutment position.

According to the image forming apparatus in the aspects of the invention, since the upstream winding nip width is set to be smaller than the downstream winding nip width while forming the arcuate nip, improvement of the transfer efficiency when transferring the image on the photoconductor drum on the transfer belt is achieved. In particular, when the invention is applied to the image forming apparatus having four imaging units for yellow, magenta, cyan, and black, the improvement of the transfer efficiencies from the respective photoconductor drums to the transfer belt is achieved. Detailed description about these points will be given later using results of experiment.

### BRIEF DESCRIPTION OF THE DRAWINGS

The invention will be described with reference to the accompanying drawings, where like numbers reference like elements.

FIG. 1 is an explanatory drawing showing principal components which constitute image forming apparatuses according to first to third embodiments.

FIG. 2 is a partly enlarged drawing of FIG. 1.

FIG. 3 is an explanatory drawing for explaining a state of supporting a primary transfer roller.

FIG. 4A is an explanatory drawing for explaining characteristics of the first and second embodiments.

FIG. 4B is an explanatory drawing for explaining characteristics of the third embodiment.

FIG. 5 is an explanatory drawing for explaining characteristics of a comparative example (example in the related art).

FIG. 6 is a table showing results of a performance test and a comparative test.

FIG. 7 is an explanatory drawing showing principal components which constitute an image forming apparatus according to a fourth embodiment.

FIG. 8 is a partly enlarged drawing of FIG. 7.

FIG. 9 is an explanatory drawing showing principal components which constitute an image forming apparatus according to a fifth embodiment.

FIG. 10 is an explanatory drawing showing principal components which constitute an image forming apparatus according to a sixth embodiment.

FIG. 11 is a partly enlarged drawing of FIG. 10.

FIG. 12 is an explanatory drawing showing principal components which constitute an image forming apparatus according to a seventh embodiment.

FIG. 13 is a partly enlarged drawing of FIG. 12.

### DESCRIPTION OF EXEMPLARY EMBODIMENTS

Referring now to drawings, embodiments of the invention will be described below. In the embodiments of the invention, an image forming apparatus of a liquid developing system is exemplified for description. However, the invention is also applicable to an image forming apparatus of a dry-type electrophotographic process.

### A. First Embodiment to Third Embodiment

### a. Common Configuration

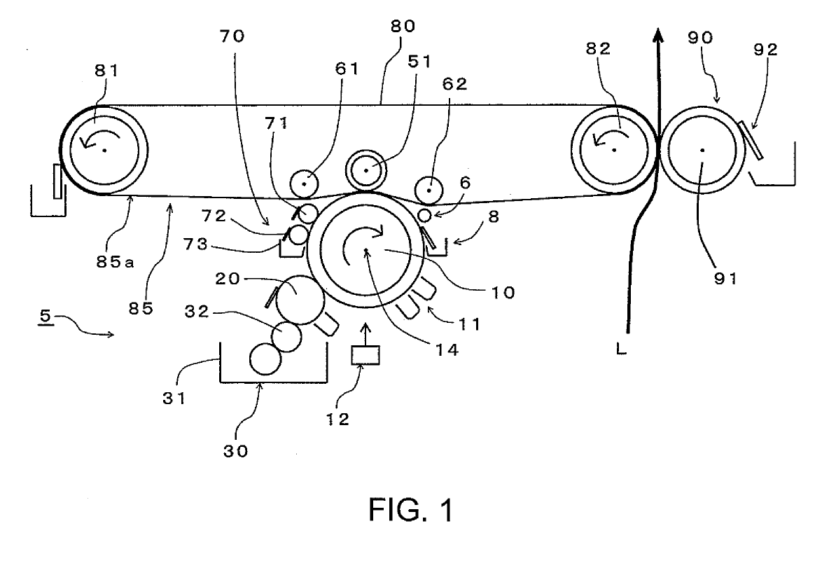

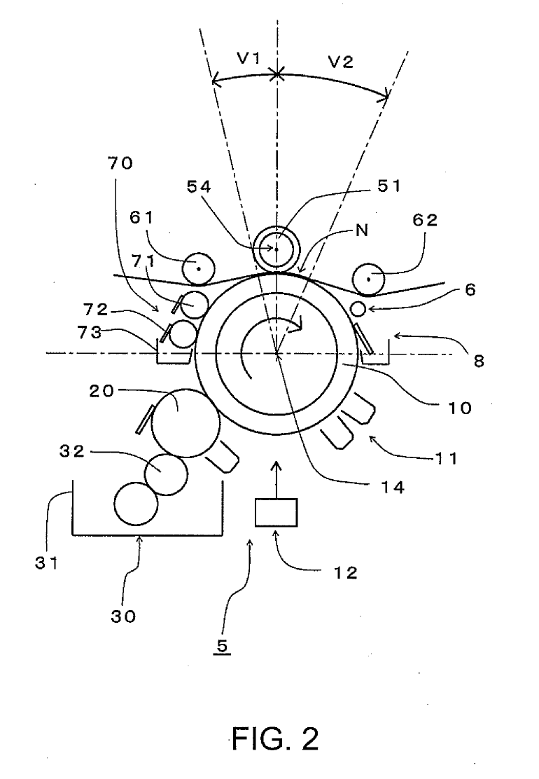

A configuration common to image forming apparatuses according to first to third embodiments will be described in brief. The image forming apparatuses in the first to third embodiments are so-called a “single color machine” and, as shown in FIG. 1 and FIG. 2, include an imaging unit 5, an intermediate transfer belt 80, a first roller 81, a second roller 82, a first support roller 61, a second support roller 62, and a second transfer unit 90. The imaging unit is disposed between the first roller 81 and the second roller 82, and includes a photoconductor drum 10, a latent image eraser 6, a cleaning device 8, a charging member 11, an exposure unit 12, a developing unit 30, a photoconductor drum squeezing device 70, and a primary transfer roller 51.

The photoconductor drum 10 is formed into a substantially cylindrical shape (outer diameter: 80 mm) formed with a photoconductive layer on an outer peripheral surface, and the outer peripheral surface rotates in a direction to come into contact with the latent image eraser 6, the cleaning device 8, the charging member 11, the exposure unit 12, the developing unit 30, and the photoconductor drum squeezing device 70 in this order. The photoconductive layer of the photoconductor drum 10 is formed of an amorphous silicon image carrier.

The charging member 11 employs a corona charger, and a bias of the same polarity as the charged polarity of liquid developer is applied from a power source device, not shown, to charge the photoconductor drum 10. The charging member 11 may be configured with a charging roller. The exposure unit 12 is configured to form a latent image by irradiating the photoconductor drum 10 with an optical image from an LED head, a laser scanning optical system or the like.

The developing unit 30 includes a developing roller 20, a developer container 31 configured to store the liquid developer in black (K), and a developer supply roller 32 configured to supply the liquid developer from the developer container 31 to the developing roller 20. Then, the latent image formed on the photoconductor drum 10 is developed by the developing unit 30. In this embodiment, the liquid developer including toner particles and carrier liquid (for example, nonvolatile liquid carrier) is employed as the developer to be stored in the respective developer containers 31. As the toner, particles having colorant such as a pigment dispersed in a thermoplastic resin may be used. As the carrier liquid, in the case of the liquid developer at a low viscosity and a low density, for example, an insulative liquid carrier such as Isoper (Trademark: Exxson Corporation) may be used. In addition, the liquid developer stored in the developer container 31 may be liquid developer in a color other than black (K), that is, yellow (Y), magenta (M), or cyan (C).

The photoconductor drum squeezing device 70 is arranged in a state opposing the photoconductor drum 10 at a portion positioned above the developing unit 30 and below the intermediate transfer belt 80. In other words, the photoconductor drum squeezing device 70 is arranged on the downstream side of the developing unit 30 along the direction of rotation of the photoconductor drum 10, and collects an excessive developer on the photoconductor drum 10. The photoconductor drum squeezing device 70 includes two squeezing rollers 71, cleaning blades 72, and collecting containers 73 provided for the respective squeezing rollers 71.

The squeezing rollers (diameter; 20 mm) 71 are an example of a “squeezing member”, each including a metallic base portion and a substantially cylindrical surface layer portion (thickness; 2.5 mm, hardness; JIS-30°) formed into a substantially cylindrical shape and mounted on an outer peripheral portion of the base portion (for example, urethane rubber). The electric resistance value of the squeezing rollers 71 when a voltage of 100V is applied is 10⁴ Ωcm. The squeezing roller (diameter; 20 mm) 71 is configured to rotate in the reverse direction from the photoconductor drum 10 in sliding contact with the photoconductor drum 10 to remove the carrier liquid from the surface of the photoconductor drum 10. The respective cleaning blades 72 are formed of a resilient material such as rubber, and are pressed against, and brought into abutment with the corresponding squeezing rollers 71 to scrape off and remove the carrier liquid remaining on the squeezing rollers 71. Furthermore, the collecting containers 73 as a collecting member corrects the developer scraped off by the respective cleaning blades 72.

The first roller 81 and the second roller 82 are arranged at a predetermined distance in the horizontal direction. The intermediate transfer belt 80 is formed into an endless belt, and is an example of a transfer belt. The intermediate transfer belt 80 is wound around and tensed between the first roller 81 and the second roller 82, and circulates between the first roller 81 and the second roller 82 while being rotated by the second roller 82 which constitutes a drive roller. The first roller 81 is a tension roller configured to provide a tensile force to the intermediate transfer belt 80.

A portion 85a of an outer peripheral surface 85 of the intermediate transfer belt 80 which circulates between the first roller 81 and the second roller 82 being transferred from the first roller 81 to the second roller 82 comes into contact with the photoconductor drum 10 with its front surface faced downward. The intermediate transfer belt 80 is an endless belt formed of conductive polyimide (belt width; 324 mm, thickness; 80 μm), and is an example of a transfer belt. The “electric resistance (volume resistance value when a voltage of 250V is applied”) of the intermediate transfer belt 80 is “10¹⁰ Ωcm”. However, a resilient intermediate transfer belt (belt width; 324 mm, thickness; 290 μm, electric resistance of an entire layer; 10¹⁰ Ωcm) having a base material layer (thickness; 80 μm) formed of conductive polyimide, a resilient layer (thickness; 200 μm, JIS-A30 degrees) formed of urethane rubber and a coat layer (thickness; 10 μm) formed of fluorinated resin (PFA or the like), fluorinated rubber or the like are laminated in this order may be used instead of the intermediate transfer belt 80.

The primary transfer roller (outer diameter; 30 mm, electric resistance; 10⁴Ω) 51 is a so-called “bias roller” and comes into abutment with the photoconductor drum 10 in a state of interposing the intermediate transfer belt 80. The primary transfer roller 51 includes the base portion formed of metal and a substantially cylindrical surface layer portion (thickness; 5.0 mm, material; urethane rubber, hardness; JIS-30°) formed into a substantially cylindrical shape and mounted on the outer peripheral portion of the base portion. The electric resistance value of the primary transfer roller 51 when a voltage of 100V is applied is 10⁴Ω.

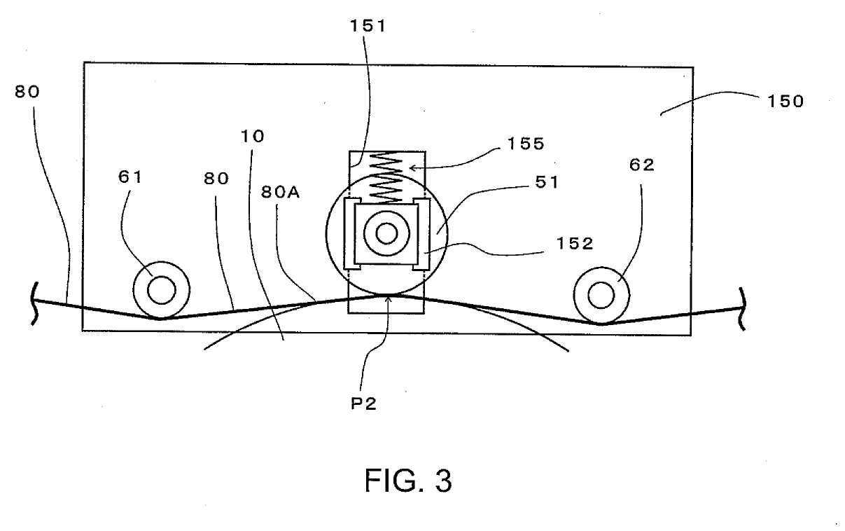

As shown in FIG. 3, the primary transfer roller 51 is supported by a supporting member 150 so as to be slidable in the vertical direction. The primary transfer roller 51 is pressed toward rotation centers 14 of the photoconductor drum 10 using an urging force of a resilient member (urging device) 155 while disposing a rotation center 54 thereof at a position vertically higher than the rotation centers 14 of the photoconductor drum 10 (see FIG. 2), so as to apply a predetermined load (primary transfer load; 5 kgf) toward the intermediate transfer belt 80 and the photoconductor drum 10. In other words, a slider 152 configured to rotatably support the primary transfer roller 51 is mounted into a slide hole 151 formed on the supporting member 150 so as to be capable of moving up and down in the vertical direction. In addition, since the slider 152 is urged downward in the vertical direction by the urging device (spring) 155 mounted on the supporting member 150, a certain load is applied from the primary transfer roller 51 toward the intermediate transfer belt 80 and the photoconductor drum 10.

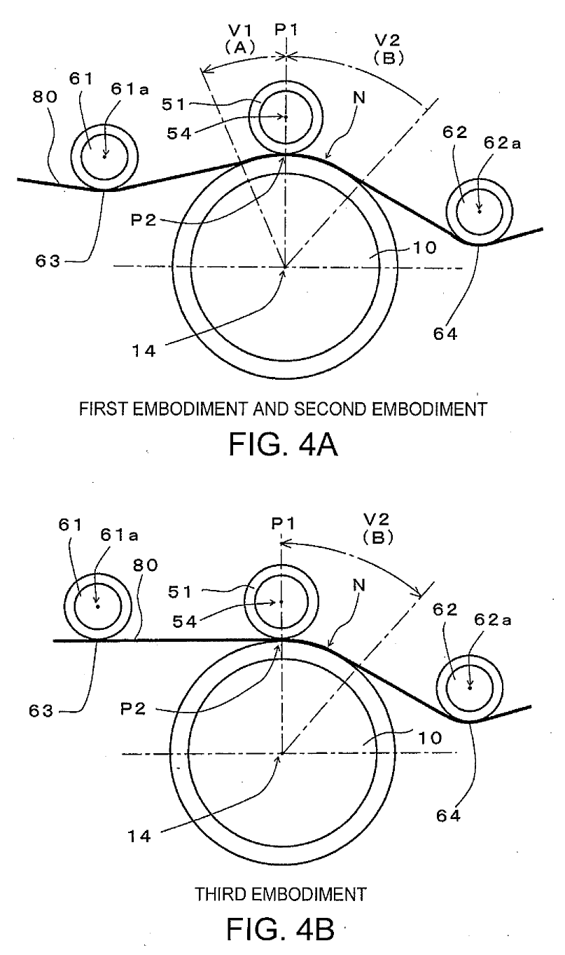

When a bias is applied to the primary transfer roller 51, a developed toner image adhered on the photoconductor drum 10 is transferred to the outer peripheral surface 85 of the intermediate transfer belt 80, and a single-colored toner image is formed on the outer peripheral surface 85 of the intermediate transfer belt 80. As shown in FIGS. 4A and 4B, in the first to third embodiments, a straight line P1 connecting the axial center (rotation center) 54 of the primary transfer roller 51 and the axial center (rotation center) 14 of the photoconductor drum 10 is a vertical straight line, and an intersecting point P2 between the straight line P1 and the outer peripheral surface of the photoconductor drum 10 is positioned at an upper end portion of the photoconductor drum 10.

The latent image eraser 6 and the cleaning device 8 are arranged in this order on the downstream side of the straight line P1 with respect to the photoconductor drum 10. The latent image eraser 6 is a member configured to erase the latent image on the photoconductor drum 10 after a primary transfer step by the primary transfer roller 51, and the cleaning device 3 is a member configured to remove “developer which is not transferred to the intermediate transfer belt 80 at the time of the primary transfer step and is remaining on the photoconductor drum 10” from the photoconductor drum 10.

The first support roller 61 and the second support roller 62 are metallic rollers (outer diameter; 12 mm), and as shown in FIG. 3, and presses the “a portion 80A of the intermediate transfer belt 80 transported from the first roller 81 toward the second roller 82” from above by being supported at a fixed position of the above-described supporting member 150 in a rotatable state. However, the first support roller 61 is arranged on the side of the first roller 81 with respect to the primary transfer roller 51 (hereinafter, referred to as the “upstream side of the primary transfer roller 51”), and the second support roller 62 is arranged on the side of the second roller 82 with respect to the primary transfer roller 51 (hereinafter, referred to as the “downstream side of the primary transfer roller 51”). Then, the intermediate transfer belt 80 is wound around the photoconductor drum 10 and forms an arcuate nip N.

In the first to third embodiments, the support rollers 61 and 62 are arranged on the upstream side and the downstream side of the primary transfer roller 51, and the intermediate transfer belt 80 is pressed downward. Therefore, although a transport path of the intermediate transfer belt 80 is turned tightly whereby the tension is increased, the primary transfer roller 51 is prevented from being lifted unintentionally by the tension of the intermediate transfer belt 80. Since the primary transfer roller 51 may be brought into abutment with the photoconductor drum 10 at a specified pressure (primary transfer load; 5 kgf), according to the image forming apparatuses according to the first to third embodiments, the preferable transfer efficiency is achieved from this point of view.

The second transfer unit 90 includes a second transfer roller 91 and a cleaning device 92 arranged in a state of opposing the second roller 82 with the intermediary of the intermediate transfer belt 80. Then, at a transfer position where the second transfer roller 91 is arranged, the toner image formed on the intermediate transfer belt 80 is transferred to a recording medium (sheet, film, cloth, etc.) transported through a recording medium transporting path L. Then, the toner image transferred to the recording medium is fixed to the recording medium using a fixing unit, not shown.

### b. Characteristic Configurations

Subsequently, characteristic configurations of the image forming apparatuses according to the first to third embodiments and a comparative example will be described. In any image forming apparatuses, a “distance between rotation centers 61a and 54 of the first support roller 61 and the primary transfer roller 51 along the horizontal direction” and a “distance between rotation centers 62a and 54 of the second support roller 62 and the primary transfer roller 51 along the horizontal direction” are constant.

### b-1. First and Second Embodiments

In the first and second embodiments, as shown in FIG. 4A, a lower end portion 63 of the first support roller 61 is arranged at a position lower than the intersecting point P2 as described above, and a lower end portion 64 of the second support roller 62 is arranged at a position further lower than the lower end portion 63 of the first support roller 61. Accordingly, a center angle V2 of “a segment which constitutes a segment positioned on the downstream side thereof along the direction of movement of the intermediate transfer belt 80 (that is, the downstream winding nip segment B)” is set to be larger than a center angle V1 of “a segment of the arcuate nip N positioned on the upstream side of the straight line P1 connecting the axial center 54 of the primary transfer roller 51 and the axial center 14 of the photoconductor drum 10 along the direction of movement of the intermediate transfer belt 80 (that is, the upstream winding nip segment A)” from a straight line P1 connecting the axial center 54 of the primary transfer roller 51 and the axial center 14 of the photoconductor drum 10 in the arcuate nip N.

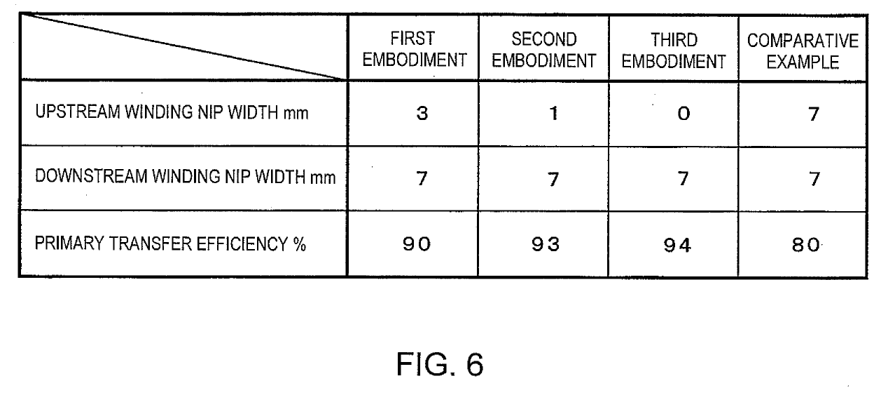

Therefore, in the first and second embodiments, the width of a portion of the nip N which constitutes the downstream winding nip segment B (hereinafter, referred to as the “downstream winding nip width”) is set to be larger than the width of a portion thereof which constitutes the upstream winding nip segment A (hereinafter, referred to as the “upstream winding nip width”). In other words, in the first and second embodiments, when viewing an axial cross-section of the photoconductor drum 10, the intermediate transfer belt 80 comes into contact with the photoconductor drum 10 at a “contact position positioned in the reverse direction of rotation from the direction of rotation of the photoconductor drum 10 with respect to the above-described intersecting point P2”, is wound around the photoconductor drum 10 in the direction of rotation thereof, is positioned apart from the photoconductor drum 10 at a “separated position positioned in the direction of rotation of the photoconductor drum 10 with respect to the above-described intersecting point P2”, and the “peripheral surface length of the photoconductor drum 10 from the intersecting point P2 to the separated position (corresponding to the downstream winding nip width)” is longer than the “peripheral surface length of the photoconductor drum 10 from the contact position to the intersecting point P2 (corresponding to the upstream winding nip width)”. However, although the heights of the lower end portion 64 of the second support roller 62 are equal in the first and second embodiments, the height of the lower end portion 63 of the first support roller 61 in the first embodiment is lower than that in the second embodiment, so that the upstream winding nip width in the first embodiment is larger than that of the second embodiment. When expressing it in specific figures, as shown also in FIG. 6, the upstream winding nip width is “3 mm” and the downstream winding nip width is “7 mm” in the first embodiment, while the upstream winding nip width is “1 mm”, and the “downstream winding nip width is “7 mm” in the second embodiment.

### b-2. Third Embodiment

In the third embodiment, as shown in FIG. 4B, the lower end portion 63 of the first support roller 61 is arranged substantially the same height as a lower end portion of the primary transfer roller 51, and the lower end portion 64 of the second support roller 62 is arranged at a position further lower than the lower end portion 63 of the first support roller 61. Therefore, the arcuate nip N includes only the downstream winding nip segment B. In other words, the center angle V1 of the portion of the nip N which constitutes the upstream winding nip segment A is “zero”. When expressing it in specific figures, the upstream winding nip width is “zero mm” in the first embodiment, and the downstream winding-nip width is “7 mm”.

### b-3. Comparative Example

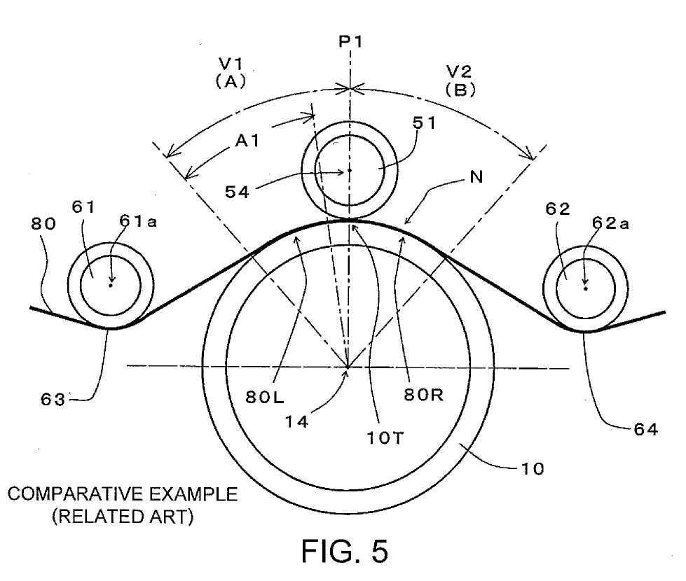

In order to evaluate performances of the image forming apparatuses in the first to third embodiments, the “image forming apparatus according to the comparative example” is also used as an objective of the performance test described later. This comparative example is different from the first embodiment in that the height of the lower end portion 63 of the first support roller 61 is determined to be the same as the height of the lower end portion 64 of the second support roller 62 as shown in FIG. 5. However, other points are the same as those in the first embodiment. Therefore, in the comparative example, the center angle V1 of a portion of the arcuate nip N which constitutes the upstream winding nip segment A and the center angle V2 of a portion thereof which constitutes the downstream winding nip segment B are equalized. Then, in the comparative example, the upstream winding nip width and the downstream winding nip width are both set to “7 mm”.

### c. Performance Test

Subsequently, the performance test conducted for evaluating the performances of the image forming apparatuses in the first to third embodiments will be described. The performance test is for evaluating the effects generated by realizing the “downstream winding nip width≧upstream winding nip width”, and is conducted by calculating the transfer efficiency of the imaging unit 5. The “transfer efficiency” is calculated by measuring the “change in optical density of the toner” on the photoconductor drum 10 using an “X-Lite optical measurement”.

More specifically, it is calculated by using (i) the optical density of the toner adhered on the outer peripheral surface of the photoconductor drum 10 in a stage after the developer (black developer) is received from the developing unit 30, and passed through the photoconductor drum squeezing device 70, and before the toner image is transferred to the intermediate transfer belt 80 (hereinafter, referred to as “optical density of the toner before transfer”), and (ii) the optical density of the toner adhered on the outer peripheral surface of the photoconductor drum 10 in a stage after the toner image is transferred to the intermediate transfer belt 80 and before reaching the cleaning device 8 (hereinafter, referred to as the “optical density of the toner after transfer”).

More specifically, the transfer efficiency from the photoconductor drum 10 to the intermediate transfer belt 80 is calculated using the following expression.

transfer efficiency [%]={(“optical density of the toner before transfer”−“optical density of the toner after transfer”)/(optical density of the toner before transfer)}×100

This performance test is conducted under environmental conditions of “a room temperature of 23° C.”, “a humidity of 65%”, and “a bias (V) to be applied to the primary transfer roller 51 of “−400V”. The result of the performance test is shown in FIG. 6. In this embodiment, the same performance test is performed for the image forming apparatus according to the comparative example.

FIG. 6 is a table showing the relation between “how to wind” and “primary transfer efficiency”. According to this table, in the comparative example in which the upstream winding nip width and the downstream winding nip width are equalized, the transfer efficiency does not exceed 80% even though the bias (V) is reached to “−400V”. In contrast, in the first and second embodiments in which the downstream winding nip width is set to be larger than the upstream winding nip width and the third embodiment in which the upstream winding nip width is set to “zero”, a high transfer efficiency of “90%” or more is obtained when the bias (V) is reached to “−400V”. In addition, when the first to third embodiments are compared, the smaller the upstream winding nip width, the more the transfer efficiency is improved.

The inventors assume the reason why the results as described above are obtained as follows. That is, it is considered that means for improving the transfer efficiency is to form the arcuate nip N and increase the amount of contact of the intermediate transfer belt 80 with respect to the photoconductor drum 10. However, when the upstream winding nip segment A is provided and the intermediate transfer belt 80 and a toner layer on the photoconductor drum 10 comes into contact with each other at a portion A1 on the upstream winding nip segment A1 where an electric field is not provided (see FIG. 5), it is considered that the toner layer is mechanically pressed against the photoconductor drum 10 so that the toner layer can hardly be separated from the photoconductor drum 10, or electric charge of the toner becomes unstable due to electric discharge at a minute gap in the upstream winding nip segment A, whereby the transfer efficiency is lowered.

Therefore, it is understood that when the upstream winding nip width is relatively larger than the downstream winding nip width, the transfer efficiency is lowered although the amount of contact of the intermediate transfer belt 80 with respect to the photoconductor drum 10 is increased. In other words, when the nip N is formed and the upstream winding nip width is relatively reduced with respect to the downstream winding nip width while increasing the amount of contact of the intermediate transfer belt 80 with respect to the photoconductor drum 10, a high transfer efficiency is obtained in cooperation with the fact that “the arcuate nip N is formed and the amount of contact of the intermediate transfer belt 80 with respect to the photoconductor drum 10 is increased”.

### d. Advantages of The First Embodiment

As shown by the performance test described above, in the first and second embodiments in which the downstream winding nip width is set to be larger than the upstream winding nip width while forming the arcuate nip N and the third embodiment in which the upstream winding nip width is set to “zero” while forming the arcuate nip N, a high transfer efficiency of “90%” or more is obtained when the bias (V) is reached to “−400V”.

### B. Fourth Embodiment

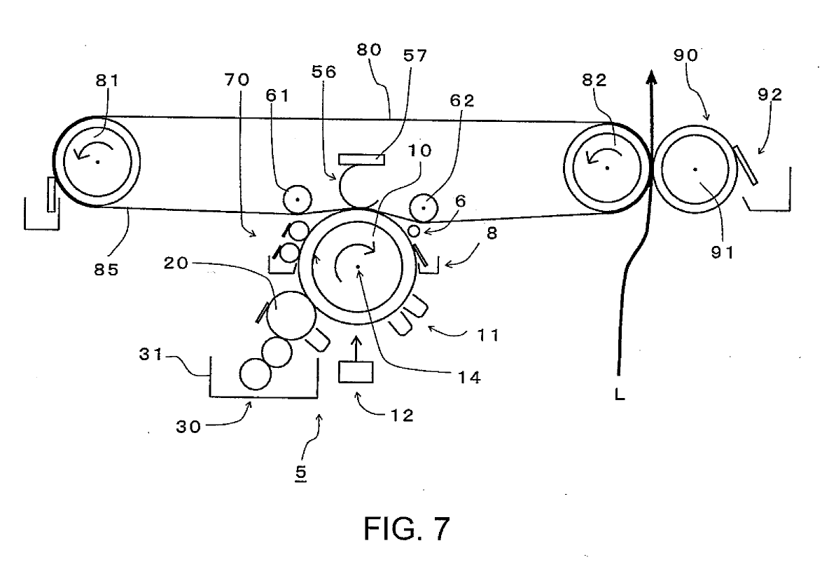

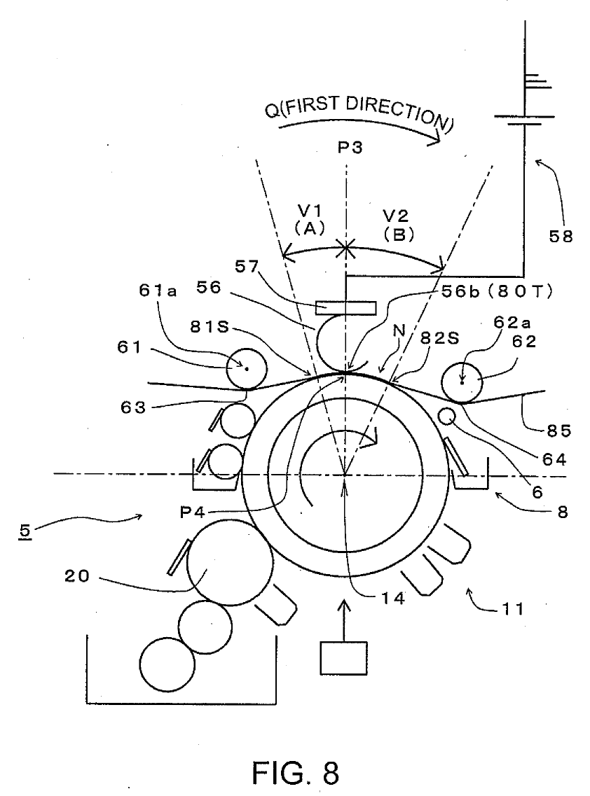

The image forming apparatus according to a fourth embodiment is different from the image forming apparatus according to the first embodiment in the following points. In other words, as shown in FIG. 7 and FIG. 8, the fourth embodiment is different from the first embodiment in that a spring shaped transfer member 56 is used instead of the primary transfer roller 51. Here, the transfer member 56 has conductivity and is formed into a leaf spring shape curved into an arcuate shape, and is fixed to a fixing member 57 at one end thereof. Also, a bias is applied to the transfer member 56 using an applying unit 58. The transfer member 56 may be configured by using, for example, a resin sheet having conductivity.

The fixing member 57 is supported by the supporting member 150 described above (not shown) and the transfer member 56 is projected downward. Then, the transfer member 56 is deflected so as to increase its curvature and a free end-side portion (hereinafter, referred to as “abutting portion”) 56b is in contact with the intermediate transfer belt 80. Therefore, the abutting portion 56b of the transfer member 56 is in abutment with the photoconductor drum 10 in a state in which the intermediate transfer belt 80 is interposed therebetween. Then, when a bias is applied to the transfer member 56, the developed toner image adhered on the photoconductor drum 10 is transferred to the outer peripheral surface 85 of the intermediate transfer belt 80, and a single-colored toner image is formed on the outer peripheral surface 85 of the intermediate transfer belt 80.

In this embodiment, a straight line P3 connecting “a position where the abutting portion 56b comes into abutment with the intermediate transfer belt 80 (that is, an abutment position) 80T” and “the rotation center 14 of the photoconductor drum 10” is a vertical straight line, and an intersecting point P4 between the straight line P3 and the photoconductor drum 10 is positioned at an upper end portion of the photoconductor drum 10. Then, the photoconductor drum 10 rotates in the direction indicated by an arrow Q in FIG. 8 with respect to the abutment position 80T. Then, the intermediate transfer belt 80 transported from the first roller 81 toward the second roller 82 starts coming into contact with the photoconductor drum 10 at “a first position 81S positioned on the upstream side of the abutment position 80T along the transporting direction”. Then, after having moved in the direction indicated by the arrow Q in FIG. 8 while being wound around the photoconductor drum 10, it moves away from the photoconductor drum 10 at “a second position 82S positioned on the downstream side of the abutment position 80T along the transporting direction”.

In the fourth embodiment as well, arrangements of the first support roller 61 and the second support roller 62 are the same as those in the first embodiment and, in addition, the abutting portion 56b comes into abutment with the upper end portion of the photoconductor drum 10 via the intermediate transfer belt 80. Then, as in the same manner as the first embodiment, the upstream winding nip width is “3 mm” and the downstream winding nip width is “7 mm”. In this manner, in the fourth embodiment as well, since the downstream winding nip width is set to be larger than the upstream winding nip width while forming the arcuate nip N, a high transfer efficiency is obtained. Although the fourth embodiment is configured as a modification of the first embodiment, the fourth embodiment may be configured as a modification of the second embodiment or the third embodiment.

### C. Fifth Embodiment

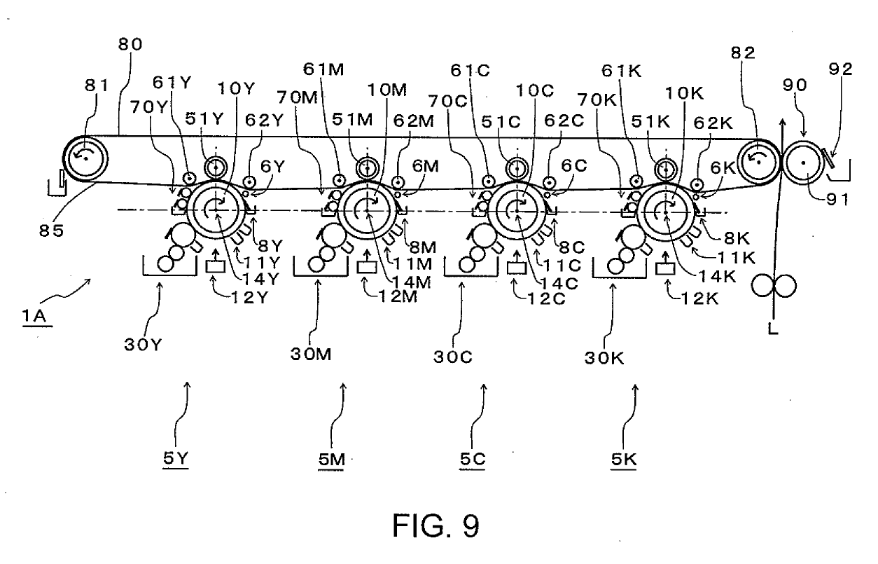

Subsequently, an image forming apparatus 1A according to a fifth embodiment will be described in brief. The image forming apparatus 1A is different from that in the first embodiment in being so-called a “color machine”. In other words, the image forming apparatus 1A in the fifth embodiment includes, as shown in FIG. 9, four in total imaging units 5Y, 5M, 5C, and 5K for yellow (Y), magenta (M), cyan (C), and black (K), the intermediate transfer belt 80, the first roller 81, the second roller 82, first support rollers 61Y, 61M, 61C, and 61K arranged for the respective imaging units 5Y, 5M, 5C, and 5K, second support rollers 62Y, 62M, 62C, and 62K arranged for the respective imaging units 5Y, 5M, 5C, and 5K, and the second transfer unit 90. The respective imaging units 5Y, 5M, 5C, and 5K for yellow (Y), magenta (M), cyan (C), and black (K) are arranged in this order between the first roller 81 and the second roller 82 along the horizontal direction.

The respective imaging units 5Y, 5M, 5C, and 5K include photoconductor drums 10Y, 10M, 10C, and 10K, latent image erasers 6Y, 6M, 6C, and 6K, cleaning devices 8Y, 8M, 8C, and 8K, charging members 11Y, 11M, 11C, and 11K, exposure units 12Y, 12M, 12C, and 12K, developing units 30Y, 30M, 30C, and 30K, photoconductor drum squeezing devices 70Y, 70M, 70C, and 70K, and primary transfer rollers 51Y, 51M, 51C, and 51K. In the embodiment showing the “color machine”, reference numerals which designate the respective components correspond to the reference numerals of the same components in the single color machine (such as the first embodiment). However, alphabets of Y, M, C, and K indicating the color of the “developers” used in the corresponding imaging units 5Y, 5M, 5C, and 5K are added to reference numerals which designate the respective components which constitute the respective imaging units 5Y, 5M, 5C, and 5K.

The imaging units 5Y, 5M, 5C, and 5K in the fifth embodiment have the similar configuration to the imaging unit 5 in the first embodiment. The positional relationships between the first support rollers 61Y, 61M, 61C, and 61K and the corresponding photoconductor drums 10Y, 10M, 10C, and 10K arranged for the respective imaging units 5Y, 5M, 5C, and 5K are the same as the positional relationship of the first support roller 61 with respect to the photoconductor drum 10 in the first embodiment. The positional relationships between the second support rollers 62Y, 62M, 62C, and 62K and the corresponding photoconductor drums 10Y, 10M, 10C, and 10K arranged for the respective imaging units 5Y, 5M, 5C, and 5K are the same as the positional relationship of the second support roller 62 with respect to the photoconductor drum 10 in the first embodiment as well. Therefore, in the image forming apparatus 1A in the fifth embodiment, the upstream winding nip width is “3 mm” and the downstream winding nip width is “7 mm” in all the imaging units 5Y, 5M, 5C, and 5K.

In the image forming apparatus 1A, as shown in FIG. 9, the four photoconductor drums 10Y, 10M, 10C, and 10K having the same outer diameter are arranged equidistantly with rotation centers 14Y, 14M, 14C, and 14K aligned at the same height. The intermediate transfer belt 80 circulating between the first roller 81 and the second roller 82 come into contact with the respective photoconductor drums 10Y, 10M, 10C, and 10K in the order of the photoconductor drum 10Y, the photoconductor drum 10M, the photoconductor drum 10C, and the photoconductor drum 10K. When a bias is applied to the respective primary transfer rollers 51Y, 51M, 51C, and 51K, the developed toner images in the respective colors adhered to the photoconductor drums 10Y, 10M, 10C, and 10K are transferred to the outer peripheral surface 85 of the intermediate transfer belt 80, and a full-color toner image (full-color toner image or single-colored toner image) is formed on the outer peripheral surface 85 of the intermediate transfer belt 80.

In the fifth embodiment, in four in total imaging units 5Y, 5M, 5C, and 5K for yellow (Y), magenta (M), cyan (C), and black (K), an arcuate nip is formed and the downstream winding nip width is set to be larger than the upstream winding nip width. Therefore, a high transfer efficiency is obtained in the entire image forming apparatus 1A as the color machine. In addition, since the imaging units 5Y, 5M, 5C, and 5K having the same configuration and the support rollers 61Y, 61M, 61C, 61K, 62Y, 62M, 62C, and 62K are provided in parallel, the “labor and cost for designing and manufacturing in order to obtain an image forming apparatus having a high transfer efficiency” may be reduced. Although the fifth embodiment is configured as a modification of the first embodiment, the fifth embodiment may be configured as a modification of the second embodiment or the third embodiment.

### D. Sixth Embodiment

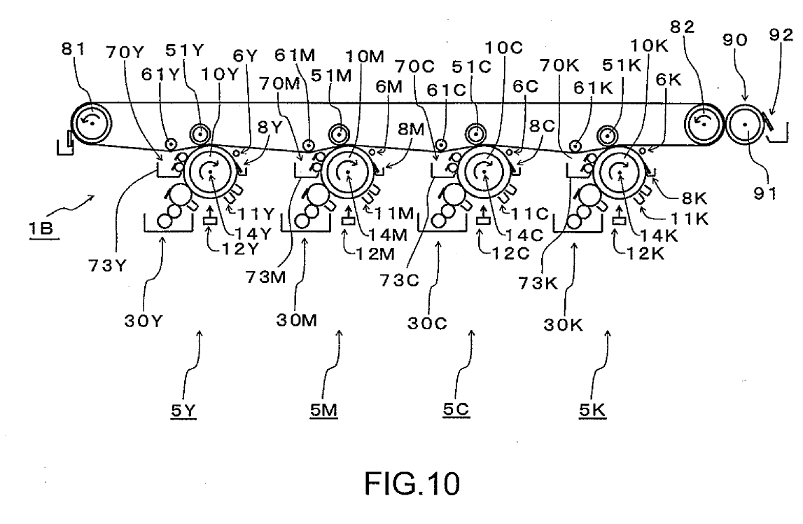

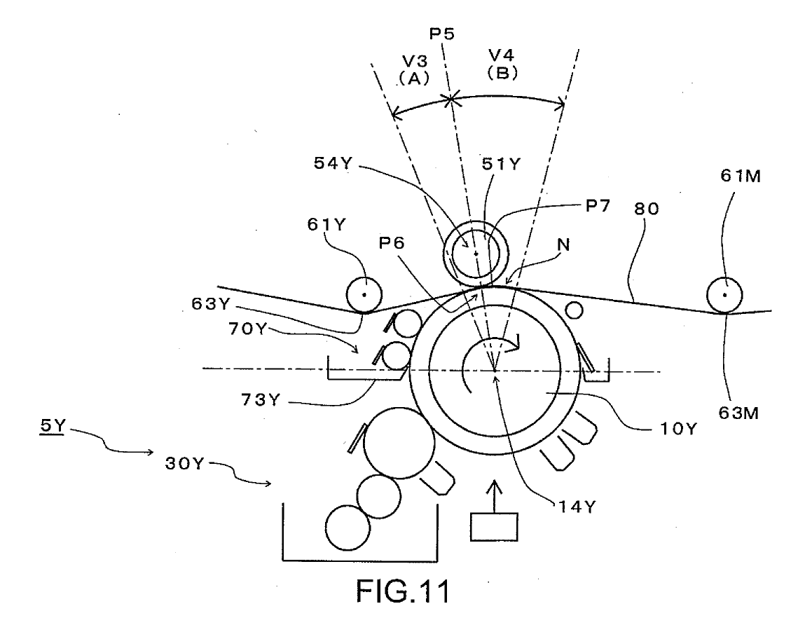

A sixth embodiment corresponds to a modification of the fifth embodiment, and is different from the fifth embodiment in the following point. In other words, in the sixth embodiment, abutment positions of the respective primary transfer rollers 51Y, 51M, 51C, and 51K with respect to the photoconductor drums 10Y, 10M, 10C, and 10K are different as shown in FIGS. 10 and 11. Also, the second support rollers 62Y, 62M, 62C, and 62K are eliminated, and the positions of the first support rollers 61Y, 61M, 61C, and 61K arranged for the respective imaging units 5Y, 5M, 5C, and 5K are changed. Hereinafter, an image forming apparatus 1B according to the sixth embodiment will be described mainly about the points different from the image forming apparatus 1A.

In the image forming apparatus 1B as well, as shown in FIG. 10, the four photoconductor drums 10Y, 10M, 10C, and 10K having the same outer diameter are arranged equidistantly with the rotation centers 14Y, 14M, 14C, and 14K aligned at the same height. However, positions at which the respective primary transfer rollers 51Y, 51M, 51C, and 51K come into abutment with the corresponding photoconductor drums 10Y, 10M, 10C, and 10K via “the intermediate transfer belt 80 which is transported from the first roller 81 to the second roller 82” are deviated toward the upstream side of the intermediate transfer belt 80 in terms of the direction of transport.

The imaging unit 5Y for yellow (Y) is exemplified for description about this point. As shown in FIG. 11, a straight line P5 connecting a rotation center 54Y of a primary transfer roller 51Y and the rotation center 14Y of the photoconductor drum 10Y is inclined upward as it goes toward the first roller 81. The position of an intersecting point P6 between the straight line P5 and the photoconductor drum 10Y is deviated from the upper end portion P7 of the photoconductor drum 10Y to the upstream side of the intermediate transfer belt 80 in terms of the direction of transport. A lower end portion 63Y of the first support roller 61Y arranged on the side of the first roller 81 with respect to the photoconductor drum 10Y is arranged at a position lower than the intersecting point P6 described above.

The intermediate transfer belt 80 transported from the direction of the first roller 81 and pressed downward by the lower end portion 63Y of the first support roller 61Y comes into contact with the photoconductor drum 10Y and passes through the intersecting point P6 and the upper end portion P7 while being inclined upward toward the second roller 82. Then, since the intermediate transfer belt 80 is transported toward a lower end portion 63M of “the first support roller 61M corresponding to the imaging unit 5M for subsequent magenta (M)” while being inclined downward, the intermediate transfer belt 80 is wound around the photoconductor drum 10Y to form the arcuate nip N. At this time, since the heights of the lower end portions 63Y and 63M of the both “the first support rollers 61Y and 61M” are lower than the intersecting point P6, and the position of the intersecting point P6 is deviated toward the upstream side of the intermediate transfer belt 80 in terms of the direction of transport, a center angle V4 of a portion which constitutes the downstream winding nip segment B is set to be larger than a center angle V3 of a portion which constitutes the upstream winding nip segment A. When expressing it in specific figures, the upstream winding nip width is “3 mm” in the sixth embodiment, and the downstream winding nip width is “7 mm”.

Although detailed description will be omitted, the nips N which are same as the photoconductor drum 10Y are formed in the photoconductor drum 10M and the photoconductor drum 10C which follow the photoconductor drum 10Y as well by the actions of the corresponding first support rollers 61M and 61C and the first support rollers 61C and 61K corresponding to the imaging units 5C and 5K. In contrast, in the sixth embodiment, since the first support roller is not arranged on the downstream side of the photoconductor drum 10K (the downstream side of the intermediate transfer belt 80 in terms of the direction of transport), the same nip N is not formed. However, the upstream winding nip width is set to be larger than the downstream winding nip width by deviating the abutment position of the primary transfer roller 51K with respect to the photoconductor drum 10K toward the upstream side of the intermediate transfer belt 80 in terms of the direction of transport, and adjusting the relative positional relationship and the size or the like of the photoconductor drum 10K and the second roller 82. The nip N which is the same as that at the imaging unit 5Y may be formed on the imaging unit 5K as well by lowering the height of a lower end portion of the second roller 82 with respect to the height of a lower end portion of the photoconductor drum 10K or by disposing “a support roller which presses the intermediate transfer belt 80 downward” between the photoconductor drum 10K and the second roller 82. However, in this embodiment, granted that the upstream winding nip width is set to be the same as the downstream winding nip width at the imaging unit 5K, or the upstream winding nip width is set to be larger than the downstream winding nip width, a high transfer efficiency is obtained as the “entire image forming apparatus 1B as the color machine” since the upstream winding nip widths are set to be smaller than the downstream winding nip widths at other imaging units 5Y, 5C, and 5M.

Although the possibility that carrier liquid drops from portions of the intermediate transfer belt 80 protruded downward by being pressed by the first support rollers 61Y, 61M, 61C, and 61K is high, handling of the carrier liquid is easy in the image forming apparatus 1B. It is because the first support rollers 61Y, 61M, 61C, and 61K arranged for the respective imaging units 5Y, 5M, 5C, and 5K are arranged above the corresponding photoconductor drum squeezing devices 70Y, 70M, 70C, and 70K in the vertical direction in the image forming apparatus 1B.

The photoconductor drum squeezing devices 70Y, 70M, 70C, and 70K include collecting containers 73Y, 73M, 73C, and 73K each having an opening opened upward in the vertical direction as described above, and the first support rollers 61Y, 61M, 61C, and 61K are arranged at a position higher than the openings. Therefore, the carrier liquids dropping from the portions of the intermediate transfer belt 80 pressed by the first support rollers 61Y, 61M, 61C, and 61K may be collected in the respective collecting containers 73Y, 73M, 73C, and 73K.

In the sixth embodiment, a high transfer efficiency is obtained in the entire image forming apparatus 1B as the color machine. In addition, since the imaging units 5Y, 5M, 5C, and 5K having the same configuration and the support rollers 61Y, 61M, 61C, and 61K are provided in parallel, and the number of the support rollers 61Y, 61M, 61C, and 61K is reduced, the “labor and cost for designing and manufacturing in order to obtain an image forming apparatus having a high transfer efficiency” may be reduced. In addition, by arranging the first support rollers 61Y, 61M, 61C, and 61K above the corresponding photoconductor drum squeezing devices 70Y, 70M, 70C, and 70K in the vertical direction, contamination by the carrier liquid is prevented.

### E. Seventh Embodiment

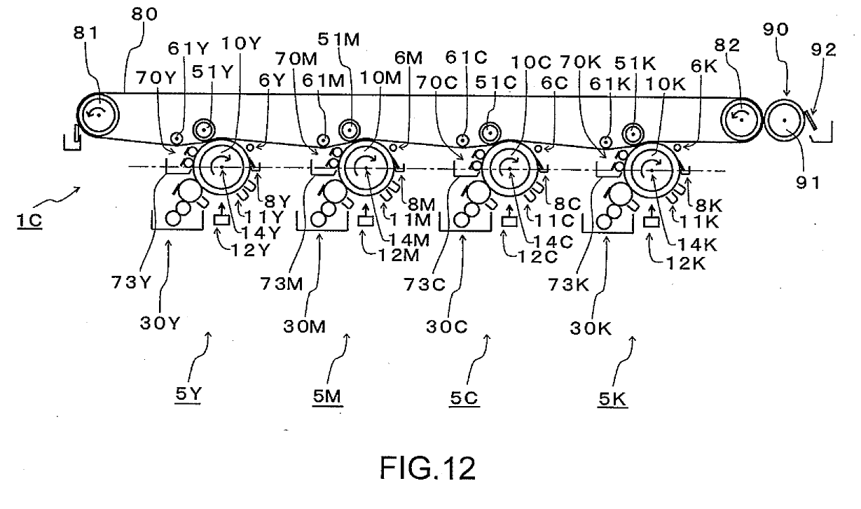

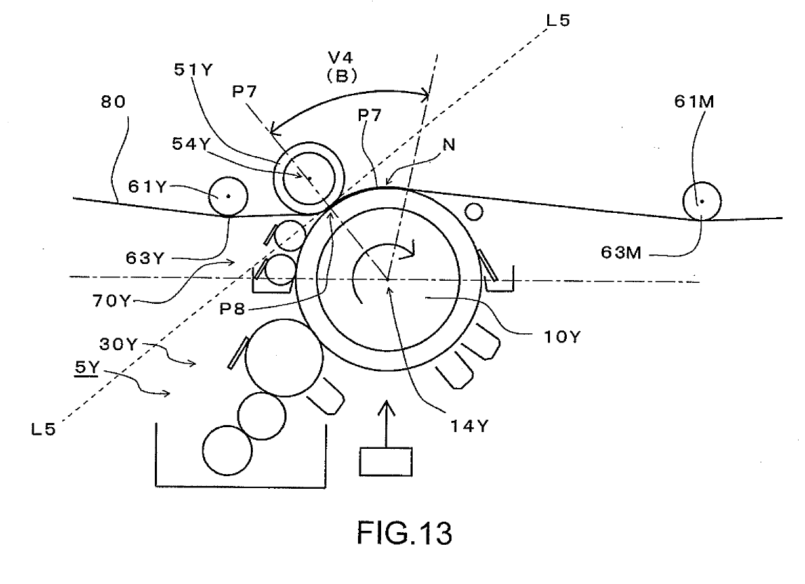

A seventh embodiment corresponds to a modification of the fifth embodiment, and is different from the fifth embodiment in the following point. In other words, in the seventh embodiment, abutment positions of the respective primary transfer rollers 51Y, 51M, 51C, and 51K with respect to the photoconductor drums 10Y, 10M, 10C, and 10K are different as shown in FIGS. 12 and 13. The second support rollers 62Y, 62M, 62C, and 62K are eliminated. In addition, the relative positions between the first support rollers 61Y, 61M, 61C, and 61K and the primary transfer rollers 51Y, 51M, 51C, and 51K arranged for the respective imaging units 5Y, 5M, 5C, and 5K are changed. Hereinafter, an image forming apparatus 1C according to the seventh embodiment will be described mainly about the points different from the image forming apparatus 1A.

In the image forming apparatus 1C as well, as shown in FIG. 12, the four photoconductor drums 10Y, 10M, 10C, and 10K having the same outer diameter are arranged equidistantly with the rotation centers 14Y, 14M, 14C, and 14K aligned at the same height. However, positions at which the respective primary transfer rollers 51Y, 51M, 51C and 51K come into abutment with the corresponding photoconductor drums 10Y, 10M, 10C, and 10K via “the intermediate transfer belt 80 which is transported from the first roller 81 to the second roller 82” are deviated toward the upstream side of the intermediate transfer belt 80 in terms of the direction of transport.

The imaging unit 5Y for yellow (Y) is exemplified for description about this point. As shown in FIG. 13, the straight line L6 connecting the rotation center 54Y of the primary transfer roller 51Y and the rotation center 14Y of the photoconductor drum 10Y is inclined upward as it goes toward the first roller 81. The position of an intersecting point P8 between the straight line L6 and the photoconductor drum 10Y is deviated from the upper end portion P9 of the photoconductor drum 10Y to the upstream side of the intermediate transfer belt 80 in terms of the direction of transport.

Although the height of the lower end portion 63Y of the first support roller 61Y arranged on the side of the first roller 81 with respect to the photoconductor drum 10Y is located at a position lower than the upper end portion P9 of the photoconductor drum 10Y, it is located at a position (the side of the primary transfer roller 51Y) higher than a common tangent line L5 of the primary transfer roller 51Y and the photoconductor drum 10Y. Therefore, the intermediate transfer belt 80 transported from the direction of the first roller 81 and reaches the first support roller 61Y comes into abutment with the first support roller 61Y first, and then comes into abutment with the primary transfer roller 51Y. Then, the intermediate transfer belt 80 is started to come into abutment with the photoconductor drum 10Y first at the intersecting point P8, then is wound around the photoconductor drum 10Y, and then is transported toward the “lower end portion 63M of the first support roller 61M corresponding to the subsequent imaging unit 5M for magenta (M)” while inclining downward thereto. Therefore, the intermediate transfer belt 80 is wound around the photoconductor drum 10Y and forms the arcuate nip N.

As described above, in the seventh embodiment, since the intermediate transfer belt 80 comes into abutment with the primary transfer roller 51Y and the photoconductor drum 10Y in this order, the upstream winding nip segment A may be eliminated from the nip N formed on the photoconductor drum 10Y. When expressing it in specific figures, the upstream winding nip width is “zero mm” in the sixth embodiment, and the downstream winding nip width is “8 mm”.

Although detailed description will be omitted, the nips N which are same as the photoconductor drum 10Y are formed in the photoconductor drum 10M and the photoconductor drum 10C which follow the photoconductor drum 10Y as well by the actions of the corresponding first support rollers 61M and 61C and the first support rollers 61C and 61K corresponding to the imaging units 5C and 5K. In contrast, although the first support roller is not arranged on the downstream side of the photoconductor drum 10K (the downstream side of the intermediate transfer belt 80 in terms of the direction of transport), since the intermediate transfer belt 80 also comes into abutment with the primary transfer roller 51K and the photoconductor drum 10K in this order, the upstream winding nip segment A may be eliminated from the nip N formed on the photoconductor drum 10K. However, the nip N which is the same as those on other photoconductor drums 10Y, 10M, and 10C may be formed by arranging a second support roller on the downstream side of the photoconductor drum 10K (the downstream side of the intermediate transfer belt 80 in terms of the direction of transport).

According to the seventh embodiment, since the upstream winding nip segment A may be eliminated from the arcuate nip N formed on each of the photoconductor drums 10Y, 10M, 10C, and 10K, a higher transfer efficiency is obtained in the entire image forming apparatus 1C as the color machine. In addition, since the imaging units 5Y, 5M, 5C, and 5K having the same configuration and the support rollers 61Y, 61M, 61C, and 61K are provided in parallel, and the number of the support rollers 61Y, 61M, 61C, and 61K is reduced, the “labor and cost for designing and manufacturing in order to obtain an image forming apparatus having a high transfer efficiency” may be reduced.

Although the respective embodiments have been described thus far, following modifications may also be exemplified in the invention described in respective claims. For example, in the image forming apparatuses in the fifth to seventh embodiments, the order of disposition of the imaging units 5Y, 5M, 5C, and 5K may be changed. For example, from the first roller 81 to the second roller 82, the imaging unit 5 may be arranged in the order of the imaging unit 5K for black (K)/, the imaging unit 5Y for yellow (Y), the imaging unit 5M for magenta (M), and the imaging unit 5C for cyan (C) from the side of the first roller 81. In this case, the imaging unit 5K for black (K) is arranged on the side of the first roller 81 with respect to the imaging units 5Y, 5M, and 5C for other three colors. Therefore, the black developer transferred to the intermediate transfer belt 80 at the imaging unit 5K for black passes through the imaging units 5Y, 5M, and 5C in other three colors, the number of times that the black developer passes through the electric field increases. In addition, since the downstream winding nip width is set to be larger than the upstream winding nip width at all the imaging units 5K, 5Y, 5M, and 5C where the black developer passes through, reservation of the higher transfer efficiency is achieved further easily

In the image forming apparatuses 1A and 1B in the fifth and sixth embodiments, the upstream winding nip width may be set to be smaller (including 0 mm) and the downstream winding nip width may be set to be larger at the imaging unit 5K for black (K). In other words, in the wet image forming apparatus, considering that the black developer can hardly be moved from the photoconductor drum 10K to the intermediate transfer belt 80 from its pigment characteristics (carbon black or the like is high in conductivity), it is considered that improvement of the transfer efficiency by relatively increasing the downstream winding nip width at the imaging unit for black is effective.

The invention is applicable to fields of selling, applying and processing or the like of, for example, printers, copying machines, and facsimile machines.

What is claimed is:

1. An image forming apparatus comprising:
a photoconductor drum;
a transfer belt wound around the photoconductor drum and configured to move in a first direction; and
a transfer member configured to come into abutment with the photoconductor drum at an abutment position via the transfer belt, wherein
the transfer belt comes into contact with the photoconductor drum at a first position and comes out of contact with the photoconductor drum at a second position, and
a peripheral surface length of the photoconductor drum between the abutment position and the second position is larger than a peripheral surface length of the photoconductor drum between the first position and the abutment position.

2. An image forming apparatus comprising:
a photoconductor drum;
a transfer belt wound around the photoconductor drum and configured to move in a first direction; and
a transfer roller configured to come into abutment with the photoconductor drum via the transfer belt, wherein
the photoconductor drum rotates in a first direction of rotation when viewing an axial cross-section of the photoconductor drum, the transfer belt comes into contact with the photoconductor drum at a contact position positioned in the direction of rotation opposite from the first direction of rotation with respect to an intersecting point between a straight line connecting axial centers of the photoconductor drum and the transfer roller and an outer peripheral surface of the photoconductor drum, is wound around the photoconductor drum in the first direction of rotation, and then comes out of contact therewith at a separated position positioned in the first direction of rotation with respect to the intersecting point, and
a peripheral surface length L2 of the photoconductor drum between the intersecting point and the separated position is larger than a peripheral surface length L1 of the photoconductor drum between the contact position and the intersecting point.

3. The image forming apparatus according to claim 2, further comprising:
a resilient member which presses the transfer roller against the photoconductor drum; and
a support roller disposed on the side of the transfer roller from between the side of the transfer roller and the side of the photoconductor drum with reference to the transfer belt and configured to press the transfer belt toward the photoconductor drum.

4. The image forming apparatus according to claim 2, wherein
the transfer belt is wound around and stretched between a first roller and a second roller and the photoconductor drum comes into abutment with a surface of the transfer belt transported from the first roller to the second roller, and
a support roller is disposed on the side of the transfer roller from between the side of the transfer roller and the side of the photoconductor drum with reference to the transfer belt and on the side of the first roller with respect to the contact position is provided.

5. The image forming apparatus according to claim 4, further comprising:
a squeezing member configured to squeeze developer on the photoconductor drum; and
a collecting member configured to collect the developer squeezed by the squeezing member are provided, wherein
the collecting member is arranged at a position below the support roller in the vertical direction, and includes an opening which opens upward in the vertical direction.

6. The image forming apparatus according to claim 4, wherein
the transfer belt comes into abutment with the support roller, the transfer roller, and the photoconductor drum in this order.

7. The image forming apparatus according to claim 2, wherein
the peripheral surface length L1 of the photoconductor drum is zero, or approximately zero.

8. An image forming apparatus comprising:
a photoconductor drum for yellow developer configured to rotate in a first direction and develop yellow developer;
a photoconductor drum for magenta developer configured to rotate in the first direction and develop magenta developer;
a photoconductor drum for cyan developer configured to rotate in the first direction and develop cyan developer;
a photoconductor drum for black developer configured to rotate in the first direction and develop black developer;
a transfer belt configured to be wound around the photoconductor drum for the black developer; and
a first transfer roller configured to come into abutment with the photoconductor drum for the black developer at an abutment position via the transfer belt, wherein
the transfer belt comes into contact with the photoconductor drum for the black developer at a first position and comes out of contact with the photoconductor drum for the black developer at a second position, and
a peripheral surface length of the photoconductor drum for the black developer between the abutment position and the second position is larger than a peripheral surface length thereof between the first position and the abutment position.
